(19) United States
(12) Patent Application Publication
(10) Pub. No.: US 2004/0253487 A1
(43) Pub. Date: Dec. 16, 2004

(54) Magnetic recording medium

(75) Inventors: Kenichi Moriwaki, Kanagawa (JP); Kazuyuki Usuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/864,578

(22) Filed: Jun. 10, 2004

(30) Foreign Application Priority Data
Jun. 10, 2003 (JP) P.2003-165450

(51) Int. Cl. B32B 3/02

(52) U.S. Cl. 428/694 TS; 428/65.3

(57) ABSTRACT

A magnetic recording medium comprising, in this order: a flexible polymer support; a gas barrier layer; an under layer; and a magnetic layer, wherein the magnetic layer has a granular structure comprising a ferromagnetic metal alloy and a nonmagnetic oxide, and a total thickness of the under layer and the magnetic layer is from 10 to 45 nm.

### FIELD OF THE INVENTION

The present invention relates to a magnetic recording medium, in particular relates to a magnetic recording medium for use in high density magnetic recording of digital information.

### BACKGROUND OF THE INVENTION

With the spread of the Internet in recent years, the use form of the computer has been changed, e.g., to the form of processing a great volume of motion picture data and sound data with a personal computer. Along with these trends, the storage capacity required of the magnetic recording media, such as hard discs, has increased.

In a hard disc apparatus, a magnetic head slightly floats from the surface of a magnetic disc with the rotation of the magnetic disc, and magnetic recording is done by non-contact recording system. This mechanism prevents the magnetic disc from breaking by the touch of the magnetic head and the magnetic disc. With the increase of the density of magnetic recording, the floating height of a magnetic head is gradually decreased, and now the floating height of from 10 to 20 nm has been realized by the use of a magnetic disc comprising a specularly polished hyper-smooth glass substrate having provided thereon a magnetic recording layer. In such a magnetic recording medium, a CoPtCr series magnetic layer and a Cr under layer are generally used, and the direction of easy magnetization of the CoPtCr series magnetic layer is controlled in the direction of in-plane of the film by the Cr under layer by increasing the temperature as high as 200 to 500° C. Further, the magnetic domain in the magnetic layer is segregated by accelerating the segregation of Cr in the CoPtCr series magnetic layer. A real recording density and recording capacity of hard disc drive have markedly increased during the past few years by technological innovation, e.g., the floating height reduction of a head, the improvement of the structure of a head, and the improvement of the recording film of a disc.

With the increase of throughput of digital data, there arises a need of moving a high capacity data, such as movie data, by recording on a commutable medium. However, since the substrate of a hard disc is made of a hard material and the distance between a head and a disc is extremely narrow as described above, there is the fear of happening of accident by the impact during operation and entraining dusts when a hard disc is used as a commutable medium such as a flexible disc and a rewritable optical disc, and so a hard disc cannot be used.

Further, when a high temperature sputtering film-forming method is used in manufacturing a magnetic recording medium, not only productivity is poor but also the cost in mass production increases, therefore, hard discs cannot be manufactured inexpensively.

On the other hand, the substrate of a flexible disc comprises a flexible polymer film and is excellent in commutability, since a flexible disc is a medium capable of contact recording, and so flexible discs can be manufactured inexpensively. However, commercially available flexible discs of nowadays have such a structure that recording layers are formed on a polymer film by coating magnetic powder with a polymer binder and an abrasive. Therefore, the high density recording characteristics of the magnetic layer of flexible discs are inferior to those of hard discs having a magnetic layer formed by sputtering, and the achieved recording density of flexible discs is only 1/10 or less of that of hard discs.

Accordingly, a ferromagnetic metal thin film type flexible disc having a recording layer formed by the same sputtering method as in hard discs is suggested. However, when it is tried to form the same magnetic layer as that of hard discs on a polymer film, the polymer film is greatly damaged by heat and it is difficult to put such a flexible disc to practical use. Therefore, it is also suggested to use highly heat resistant polyimide and aromatic polyamide films as the polymer films, but these heat resistant films are very expensive and it is also difficult to put them to practical use. When it is tried to form a magnetic layer with cooling so as not to give thermal damage to the polymer films, the magnetic characteristics of the magnetic layer are insufficient, so that recording density can be hardly improved.

On the other hand, it has come to be known that when a ferromagnetic metal thin film magnetic layer comprising a ferromagnetic metal alloy and a nonmagnetic oxide and an Ru under layer are used, almost the same magnetic characteristics as those of the CoPtCr series magnetic layer formed under a high temperature condition of from 200 to 500° C. can be obtained even when a magnetic layer is formed under room temperature. As such a ferromagnetic metal thin film magnetic layer comprising a ferromagnetic metal alloy and a nonmagnetic oxide, a so-called granular structure that is proposed in hard discs can be used (refer to, e.g., JP-A-5-73880 (The term “JP-A” as used herein refers to an “unexamined published Japanese patent application”.) and JP-A-7-311929).

However, at the time of recording and reproducing using a GMR head in further higher density recording, sufficient running durability has not been realized yet under the present conditions and there are many problems to be solved.

In direct read after write and rewritable optical discs typified by DVD-R/RW, a head and a disc are not close to each other as in a magnetic disc, and so they are excellent in commutability and widespread. However, from the thickness of light pickup and economical viewpoints, it is difficult for optical discs to take such a disc structure that both surfaces can be used as recording surfaces as in magnetic discs which are advantageous to improve capacity. In addition, the optical discs are low in areal recording density and in data transfer velocity as compared with magnetic discs, so that their performance cannot be said to be sufficient to be used as rewritable high capacity recording media.

### SUMMARY OF THE INVENTION

As described heretofore, although the requirement for rewritable high capacity commutable recording media is high, those that satisfy performances, reliability and costs are not yet realized.

Accordingly, an object of the present invention is to solve the above problems, that is, an object of the present invention is to provide an inexpensive high capacity magnetic recording medium capable of forming an under layer and a magnetic layer in this order at room temperature, having high performance and capable of highly reliable recording.

As a result of eager investigation of the prior art problems by the present inventors, the above object can be achieved by the following constitution.

That is, the present invention is as follows.

(1) A magnetic recording medium comprising a flexible polymer support having provided on at least one side of the support a gas barrier layer, an under layer and a magnetic layer in this order, wherein the magnetic layer has a granular structure comprising a ferromagnetic metal alloy and a nonmagnetic oxide, and the total thickness of the under layer and the magnetic layer is from 10 to 45 nm.

(2) The magnetic recording medium as described in the above item (1), wherein the total thickness of the under layer and the magnetic layer is from 10 to 30 nm.

That is the magnetic recording medium according to the invention has a ferromagnetic metal thin film magnetic layer having a granular structure as described later comprising a ferromagnetic metal alloy and a nonmagnetic oxide, and the total thickness of the under layer and the magnetic layer is from 10 to 45 nm. Accordingly, recording of high recording density similar to hard disc and the heightening of capacity are possible even when a magnetic layer is formed at room temperature.

The magnetic recording medium in the invention has a structure in which an under layer and a magnetic layer are grown in a columnar form. Therefore, magnetic segregation of magnetic particles is sufficiently done in a magnetic layer, so that the magnetic recording medium can have low noise characteristics in high density recording and reproduction.

Further, when a stress in the diagonal direction is applied to the magnetic recording medium at the time of head-medium contact, for obtaining sufficient resistance, the heightening of the columnar structural part is contrived by making the total thickness of the under layer and the magnetic layer (the height of the columnar structural part) 45 nm or less, by which the improvement of running durability can be ensured.

By using these magnetic layer and under layer, heating of a support (also referred to as a substrate) as conventionally performed becomes unnecessary, and a magnetic recording medium having good magnetic characteristics and running durability can be obtained even when the temperature of a substrate is room temperature. Accordingly, the present invention can provide flat magnetic tapes and flexible discs resisting to contact recording with not only a glass substrate and Al substrate but also a polymer film support without causing heat damage.

### DETAILED DESCRIPTION OF THE INVENTION

The magnetic recording medium in the invention is described in detail below.

A flexible polymer film that is preferred in the point of productivity is used as the substrate of the magnetic recording medium in the invention. The magnetic recording medium in the invention can be used as a tape medium and a flexible disc medium.

The flexible disc of the magnetic recording medium in the invention using a flexible polymer film substrate has a structure having a center hole formed in the central part, and is encased in a plastic cartridge. The cartridge is generally provided with an access window covered with a metal shutter, and a magnetic head is introduced to the flexible disc through the access window, thereby recording of signals on the flexible disc and reproduction are performed.

The magnetic recording medium according to the invention is a magnetic recording medium comprising a flexible polymer support having provided on at least one side of the support a gas barrier layer, an under layer and a magnetic layer in this order, the magnetic layer has a granular structure comprising a ferromagnetic metal alloy and a nonmagnetic oxide, and the total thickness of the under layer and the magnetic layer is from 10 to 45 nm, more preferably the total thickness of the under layer and the magnetic layer is from 10 to 30 nm.

As described above, the total thickness of the under layer and the magnetic layer of the magnetic recording medium in the invention is from 10 to 45 nm.

When the total thickness of the under layer and the magnetic layer is less than 10 nm, sufficient magnetic characteristics cannot be obtained, while when the thickness is more than 45 nm, the stress applied at the time of head-medium contact is concentrated to the under layer and the magnetic layer (the columnar structural part), which unfavorably causes the reduction of running durability.

Magnetic Layer:

A magnetic layer formed in the magnetic recording medium in the invention may be an in-plane magnetic recording layer having the axis of easy magnetization oriented in the horizontal direction to the substrate or may be a perpendicular magnetic recording layer oriented in the perpendicular direction to the substrate. The direction of the axis of easy magnetization can be controlled by the materials and crystal structure of an under layer and the composition and film forming condition of a magnetic layer.

As described above, the magnetic layer in the invention is a magnetic layer comprising a ferromagnetic metal alloy and a nonmagnetic oxide. A ferromagnetic metal alloy and a nonmagnetic oxide are mixed in a broad sense, but in a narrow sense they take the structure comprising a part where a ferromagnetic metal alloy is predominant (referred to as a part rich in a ferromagnetic metal alloy) as compared with the entire composition of the magnetic layer and a part where a nonmagnetic compound is predominant (referred to as a part rich in a nonmagnetic compound), and the segregation breadth between the parts rich in ferromagnetic metal alloys by a part rich in a nonmagnetic compound is from 0.1 to 100 Å or so.

The magnetic layer has a columnar structure by the growth of the under layer. By taking such a structure, the structure of segregation among the parts rich in ferromagnetic metal alloys by a part rich in a nonmagnetic compound becomes stable, as a result a high coercive force can be achieved, and a high output can be obtained since the magnetic susceptibility increases in a part rich in a ferromagnetic metal alloy, in addition, since the particle size becomes uniform in a part rich in a ferromagnetic metal alloy, a low noise medium can be attained.

The columnar structure of the magnetic layer can be observed with TEM. The columnar structure takes a structure in which the magnetic layer is grown by epitaxial growth with the columnar structure formed by the under layer, and the columnar structure is excellent in structural stability. The diameter of the columns of the magnetic layer is from 0.1 to 200 Å or so. A part rich in a ferromagnetic metal alloy and a part rich in a nonmagnetic compound in the magnetic layer can be confirmed by composition analysis in every point. When a part rich in a ferromagnetic metal alloy and a part rich in a nonmagnetic compound are compared, the content of Co is more in a part rich in a ferromagnetic metal alloy by 2 to 30 atomic % or so, and the content of a nonmagnetic compound is more in a part rich in a nonmagnetic compound by 2 to 50 atomic % or so.

As ferromagnetic metal alloys, alloys comprising Co and Cr, Pt, Ni, Fe, B, Si, Ta, Nb, Ru or the like can be used, and Co—Pt—Cr, Co—Pt—Cr—Ta, Co—Pt—Cr—B and Co—Ru—Cr are preferably used considering recording characteristics.

As nonmagnetic oxides, oxides of Si, Zr, Ta, B, Ti, Al, Cr, Ba, Zn, Na, La, In, Pb or the like can be used, and SiOₓ is most preferred considering recording characteristics.

The mixing ratio of ferromagnetic metal alloy to nonmagnetic oxide is preferably from 95/5 to 80/20, and particularly preferably from 90/10 to 85/15. When the mixing ratio of a ferromagnetic metal alloy is 95% or less, the segregation among magnetic particles becomes sufficient and the coercive force increases. When the mixing ratio of a ferromagnetic metal alloy is 80% or more, a high output can be obtained since the magnetic susceptibility increases.

The thickness of a magnetic layer comprising a ferromagnetic metal alloy and a nonmagnetic oxide is preferably from 5 to 40 nm, more preferably from 5 to 25 nm. When the thickness is 40 nm or less, the interaction among the columns of magnetic particles decreases by the particle growth, as a result noise lowers conspicuously. At the same time, since the magnetic layer is resistant to the stress applied at the time of head-medium contact, running durability increases, and when the thickness is 5 nm or more, the output increases.

A magnetic layer comprising a ferromagnetic metal alloy and a nonmagnetic oxide can be formed by vacuum film-forming methods, e.g., vacuum deposition and sputtering. Of these methods, a sputtering method is preferably used in the invention for capable of forming a high quality and hyper thin film with ease. As a sputtering method, any of well-known DC sputtering methods and RF sputtering methods can be used in the invention. A web sputtering system of continuously forming a layer on a continuous film is preferably used, and a batch sputtering system and an in-line sputtering system as used in the manufacture of hard discs can also be used in the present invention.

General argon gases can be used as the gas in sputtering but other rare gases can also be used. A trace amount of oxygen gas may be introduced for adjusting the oxygen contents of nonmagnetic oxides or for the purpose of surface oxidation.

For forming a magnetic layer comprising a ferromagnetic metal alloy and a nonmagnetic oxide by a sputtering method, it is possible to use two kinds of a ferromagnetic metal alloy target and a nonmagnetic oxide target and use a co-sputtering method of these two targets. However, for improving magnetic particle size variation to thereby form a uniform film, it is preferred to use an alloy target of a ferromagnetic metal alloy and a nonmagnetic oxide. The alloy target can be manufactured by a hot press method.

Under Layer:

An under layer in the magnetic recording medium in the invention is provided for the purpose of controlling the crystal orientation of the magnetic layer. It is preferred to use Ru alloys as such an under layer but alloys containing other elements can also be used. By using such an under layer, the orientation of the magnetic layer can be heightened, so that recording characteristics are improved.

The thickness of an under layer is preferably from 5 to 40 nm, particularly preferably from 5 to 30 nm. When the thickness is 40 nm or less, good productivity can be achieved, crystal particles do not thicken, noise reduces, the resistance to the stress applied at the time of head-medium contact increases, and running durability is improved. When the thickness is 5 nm or more, further improvement of magnetic characteristics can be obtained due to an under layer effect.

An under layer can be formed by vacuum film-forming methods, e.g., vacuum deposition and sputtering. Of these methods, a sputtering method is preferably used in the invention for capable of forming a high quality and hyper thin film with ease. As a sputtering method, any of well-known DC sputtering methods and RF sputtering methods can be used in the invention. A web sputtering system of continuously forming a layer on a continuous film is preferably used in the case of a flexible disc using a flexible polymer support, and a batch sputtering system and an in-line sputtering system as used in the case where an aluminum substrate and a glass substrate are used can also be used in the present invention.

General argon gases can be used as the gas in sputtering an under layer but other rare gases can also be used. A trace amount of oxygen gas may be introduced for controlling the lattice constant of an under layer.

The thickness in total of an under layer and a magnetic layer having a columnar structure is from 10 to 45 nm as described above, and from the viewpoint of the resistance to the stress applied at the time of head-medium contact, i.e., running durability, the thickness is preferably from 10 to 40 nm, and more preferably from 10 to 30 nm.

When the total thickness of an under layer and a magnetic layer is less than 10 nm, sufficient magnetic characteristics cannot be obtained, while when the thickness is more than 45 nm, the stress applied at the time of head-medium contact is concentrated to the columnar structural part, which unfavorably causes the reduction of running durability.

Gas Barrier Layer:

The magnetic recording medium in the invention is provided with a gas barrier layer between a substrate and an under layer for the purpose of the improvement of adhesion and gas barrier.

As such a gas barrier layer, a single substance of nonmetallic elements, mixtures of nonmetallic elements, or compounds comprising Ti and nonmetallic elements can be used. These materials have resistance to the stress applied at the time of head-medium contact.

The thickness of a gas barrier layer is preferably from 5 to 200 nm, particularly preferably from 5 to 100 nm. When the thickness is 200 nm or less, good productivity can be achieved, crystal particles do not thicken and noise decreases. When the thickness is 5 nm or more, a higher effect of a gas barrier layer can be obtained.

A gas barrier layer can be formed by vacuum film-forming methods, e.g., vacuum deposition and sputtering. A high quality and hyper thin film can be formed easily by a sputtering method.

Flexible Polymer Support:

Flexible polymer supports used in the magnetic recording medium in the invention are not particularly restricted but for avoiding the impact by the touch of a magnetic head and a magnetic disc, flexible resin films (flexible polymer supports) are preferably exemplified. As such resin films, resin films comprising aromatic polyimide, aromatic polyamide, aromatic polyamideimide, polyether ketone, polyether sulfone, polyether imide, polysulfone, polyphenylene sulfide, polyethylene naphthalate, polyethylene terephthalate, polycarbonate, triacetate cellulose and fluorine resin are exemplified. Polyethylene terephthalate and polyethylene naphthalate are particularly preferably used in the invention from the viewpoint of the cost and surface property, since good recording characteristics can be achieved without heating a substrate.

A lamination comprising a plurality of resin films may be used as a flexible polymer support. By using a laminated film, warp and waviness resulting from a support itself can be reduced, which conspicuously improve the scratch resistance of a magnetic layer.

As laminating methods, roll lamination by heat rollers, lamination by plate hot press, dry lamination of laminating by coating an adhesive on the adhesion surface, and lamination of using an adhesive sheet formed in advance in the form of a sheet are exemplified. The kinds of adhesives are not especially restricted and a general hot melt adhesive, a thermosetting adhesive, a UV-curable type adhesive, an EB-curable type adhesive, an adhesive sheet, and an anaerobic adhesive can be used.

The thickness of a flexible polymer support is from 10 to 200 μm, preferably from 20 to 150 μm, and more preferably from 30 to 100 μm. When the thickness of a flexible polymer support is 10 μm or more, stability at the time of high velocity rotation increases and run out decreases. While when the thickness of a flexible polymer support is 200 μm or less, the rigidity at the time of rotation lowers and it becomes possible to avoid the impact due to the touch, and a magnetic head does not jump.

The nerve of a flexible polymer support represented by the following equation is preferably from 4.9 to 19.6 MPa (from 0.5 to 2.0 kgf/mm²) when b is 10 mm, and more preferably from 6.9 to 14.7 MPa (from 0.7 to 1.5 kgf/mm²).

Nerve of flexible polymer support=Ebd³/12

In the equation, E represents a Young's modulus, b represents a film breadth, and d represents a film thickness.

The surface of a flexible polymer support is preferably as smooth as possible for performing recording by a magnetic head. The unevenness of the surface of a support markedly degrades the recording and reproducing characteristics of signals. Specifically, when an undercoat layer described later is used, the surface roughness in center line average surface roughness (Ra) measured with an optical surface roughness meter is 5 nm or less, preferably 2 nm or less, and the height of spine (projection) measured with a feeler type roughness meter is 1 μm or less, preferably 0.1 μm or less. When an undercoat layer is not used, the surface roughness in center line average surface roughness (Ra) measured with an optical surface roughness meter is 3 nm or less, preferably 1 nm or less, and the height of spine measured with a feeler type roughness meter is 0.1 μm or less, preferably 0.06 μm or less.

Besides the above-described gas barrier layer, under layer and magnetic layer, the magnetic recording medium in the invention may be provided with other layers.

For example, a flexible disc has gas barrier layers, under layers and magnetic layers on both sides of a disc-like support comprising a flexible polymer film, and the flexible disc may further have undercoat layers for improving a surface property and a gas barrier property, seed layers for increasing crystal orientation of under layers and imparting electrical conductivity just under the under layers, protective layers for protecting the magnetic layers from corrosion and abrasion, and lubricating layers for improving running durability and anticorrosion.

When these other layers are formed, it is preferred that they are laminated in the order of an undercoat layer, a gas barrier layer, a seed layer, an under layer, a magnetic layer, a protective layer and a lubricating layer.

Undercoat Layer:

It is preferred to provide an undercoat layer on the surface of a flexible polymer support for the purpose of improving a plane surface property and a gas-barrier property. For forming a magnetic layer by sputtering, it is preferred that an undercoat layer be excellent in heat resistance. As the materials of an undercoat layer, polyimide resins, polyamideimide resins, silicone resins and fluorine resins can be used. Thermosetting polyimide resins and thermosetting silicone resins have a high smoothing effect and particularly preferred. The thickness of an undercoat layer is preferably from 0.1 to 3.0 μm. When other resin films are laminated on a support, an undercoat layer may be formed before lamination processing, or may be formed after lamination processing.

As thermosetting polyimide resins, polyimide resins obtained by thermal polymerization of an imide monomer having two or more unsaturated terminal groups in the molecule, e.g., bisallylnadiimide (BANI manufactured by Maruzen Petrochemical Co., Ltd.) are preferably used. This imide monomer can be thermally polymerized at a relatively low temperature after being coated in the state of a monomer on the surface of a support, and so the material monomer can be directly coated on a support and cured. Further, this imide monomer can be used by being dissolved in ordinary solvents, is excellent in productivity and working efficiency, has a small molecular weight, and the solution of the imide monomer is low in viscosity, so that it gets into the unevenness well in coating and is excellent in smoothing effect.

As thermosetting silicone resins, silicone resins obtained by polymerization by a sol-gel method with silicone compounds having introduced an organic group as the starting material are preferably used. The silicone resins have a structure in which a part of the silicon dioxide bonds is substituted with an organic group, and the resins are greatly excellent in heat resistance as compared with silicone rubbers and more flexible than silicon dioxide films, therefore, cracking and peeling are hardly generated when a film of the silicone resins is formed on a support comprising a flexible film. In addition, since the starting material monomers can be directly coated on a support and hardened, general-purpose solvents can be used, the resins get into the unevenness well, and smoothing effect is high. Further, since condensation polymerization reaction advances from comparatively low temperature by the addition of a catalyst such as an acid and a chelating agent, hardening can be expedited, and a resin film can be formed with a general-purpose coating apparatus. Thermosetting silicone resins are excellent in a gas barrier property of shielding gases generating from a support when a magnetic layer is formed and hindering the crystallizability and orientation of the magnetic layer and the under layer, so that they can be particularly preferably used.

It is preferred to provide minute spines (texture) on the surface of an undercoat layer for the purpose of reducing the real contact area of a magnetic head and a magnetic disc and improving a tribological property. Furthermore, the handling property of a support can be improved by providing minute spines. As methods of forming minute spines, a method of coating spherical silica particles and a method of coating an emulsion to thereby form the spines of an organic substance can be used, and a method of coating spherical silica particles is preferred for ensuring the heat resistance of the undercoat layer.

The height of minute spines is preferably from 5 to 60 nm, more preferably from 10 to 30 nm. When the height of spines is 60 nm or less, deterioration of the recording/reproducing characteristics of signals by the spacing loss between the recording/reproducing heads and the medium does not occur. A higher improving effect of a tribological property can be achieved when the height of spines is 5 nm or more.

The density of minute spines is preferably from 0.1 to 100/μm², and more preferably from 1 to 10/μm². When the density of minute spines is 0.1/μm² or more, a higher improving effect of a tribological property can be obtained, and when the density is 100/μm² or less, agglomerated particles do not increase, and high spines do not increase, so that recording/reproducing characteristics are improved.

Minute spines can also be fixed on the surface of a support with a binder. It is preferred to use resins having sufficient heat resistance as the binder. As the resins having heat resistance, solvent-soluble polyimide resins, thermosetting polyimide resins and thermosetting silicone resins are particularly preferably used.

Seed Layer:

A seed layer may be provided just under an under layer of the magnetic recording medium of the present invention for the purpose of increasing crystal orientation of the under layer and imparting electrical conductivity.

As the seed layer, Ti and W alloys are preferably used, but other alloys may also be used.

The thickness of the seed layer is preferably from 1 to 30 nm. When the thickness of the seed layer is 30 nm or less, the productivity betters and the thickening tendency of crystal particles reduces. When the thickness is 1 nm or more, a higher effect of a seed layer can be obtained.

A seed layer can be formed by vacuum film-forming methods, e.g., vacuum deposition and sputtering. Of these methods, a sputtering method can form a high quality and hyper thin film with ease.

Protective Layer:

It is preferred to provide a protective layer on the surface of a magnetic layer. A protective layer is provided for the purpose of preventing the corrosion of the metallic materials contained in a magnetic layer, and preventing the abrasion of a magnetic layer by the pseudo contact or contact sliding of a magnetic head and a magnetic disc, to thereby improve running durability and anticorrosion. Materials such as oxides, e.g., silica, alumina, titania, zirconia, cobalt oxide and nickel oxide, nitrides, e.g., titanium nitride, silicon nitride and boron nitride, carbides, e.g., silicon carbide, chromium carbide and boron carbide, and carbons, e.g., graphite and amorphous carbon can be used in a protective layer.

A protective layer is a hard film having hardness equal to or higher than the hardness of the material of a magnetic head, and materials which hardly cause burning during sliding and stably maintain the effect are preferred, since such hard films are excellent in tribological durability. At the same time, materials having less pinholes are excellent in anticorrosion and preferred. As such a protective layer, hard carbon films called DLC (diamond-like carbon) manufactured by an RF plasma CVD system, an ion beam system and an ECR system are exemplified.

A protective layer may be formed by the lamination of two or more kinds of thin films having different properties. For example, it becomes possible to reconcile anticorrosion and durability on a high level by providing a hard carbon protective layer on the surface side for improving a tribological property and anitride protective layer, e.g., silicon nitride, on the magnetic recording layer side for improving anticorrosion.

Lubricating Layer:

A lubricating layer is provided on a protective layer for improving running durability and anticorrosion, if necessary. Lubricants, e.g., well-known hydrocarbon lubricants, fluorine lubricants and extreme pressure additives, are used in a lubricating layer.

As hydrocarbon lubricants, carboxylic acids, e.g., stearic acid and oleic acid, esters, e.g., butyl stearate, sulfonic acids, e.g., octadecylsulfonic acid, phosphoric esters, e.g., monooctadecyl phosphate, alcohols, e.g., stearyl alcohol and oleyl alcohol, carboxylicacidamides, e.g., stearic acid amide, and amines, e.g., stearylamine, are exemplified.

The examples of fluorine lubricants include lubricants obtained by substituting a part or all of the alkyl groups of the above hydrocarbon lubricants with fluoroalkyl groups or perfluoro polyether groups. The examples of perfluoro polyether groups include a perfluoromethylene oxide polymer, a perfluoroethylene oxide polymer, a perfluoro-n-propylene oxide polymer (CF₂CF₂CF₂O)ₙ, a perfluoroisopropylene oxide polymer [CF(CF₃)CF₂O]ₙ, and copolymers of these polymers. Specifically, perfluoromethylene-perfluoroethylene copolymers having hydroxyl groups at molecular chain terminals (FOMBLIN Z-DOL, trade name, manufactured by Ausimont K.K.) are exemplified.

As extreme pressure additives, phosphoric esters, e.g., trilauryl phosphate, phosphorous esters, e.g., trilauryl phosphite, thiophosphorous esters, e.g., trilauryl trithiophosphite, thiophosphoric esters, and sulfur extreme pressure additives, e.g., dibenzyl disulfide, are exemplified.

These lubricants can be used alone or a plurality of lubricants can be used in combination. A lubricating layer can be formed by coating a solution obtained by dissolving a lubricant in an organic solvent on the surface of a protective layer by spin coating, wire bar coating, gravure coating or dip coating, alternatively depositing the solution on the surface of a protective layer by vacuum deposition. The coating amount of a lubricant is preferably from 1 to 30 mg/m², and particularly preferably from 2 to 20 mg/m².

It is preferred to use rust preventives in combination for bettering anticorrosion. As the examples of rust preventives, nitrogen-containing heterocyclic rings, e.g., benzotriazole, benzimidazole, purine and pyrimidine, derivatives obtained by introducing alkyl side chains to the mother nuclei of these nitrogen-containing heterocyclic rings, nitrogen- and sulfur-containing heterocyclic rings, e.g., benzothiazole, 2-mercaptobenzothiazole, tetraazaindene ring compounds, thiouracil compounds, and derivatives of these nitrogen- and sulfur-containing heterocyclic rings are exemplified. A rust preventive may be mixed with a lubricant and coated on a protective layer, alternatively a rust preventive may be coated on a protective layer prior to the coating of a lubricant, and then a lubricant may be coated thereon. The coating amount of a rust preventive is preferably from 0.1 to 10 mg/m², and particularly preferably from 0.5 to 5 mg/m².

A disc-like magnetic recording medium is generally provided with each layer on both sides of a support. A tape-like medium is generally provided with each layer on one side of a support, but may be provided on both sides.

### EXAMPLES

The present invention is described in further detail below with reference to examples, however the present invention is not limited thereto.

### Example 1

An undercoat layer coating solution comprising 3-glycidoxypropyltrimethoxysilane, phenyltriethoxysilane, hydrochloric acid, aluminum acetylacetonate and ethanol was coated on a polyethylene naphthalate (PEN) film having a thickness of 63 μm and surface roughness (Ra) of 1.4 nm by gravure coating, and the coated solution was subjected to drying and curing at 100° C., thereby an undercoat layer having a thickness of 1.0 μm comprising a silicone resin was formed.

A solution comprising silica sol having a particle size of 25 nm having mixed with the above undercoat layer coating solution was coated on the undercoat layer by gravure coating, thereby spines having a height of 15 nm were formed on the undercoat layer in density of 10/μm². The undercoat layer was formed on both sides of the PEN film. The web was mounted on a web sputtering system and the following layers were formed on the undercoat layer by a DC magnetron sputtering method at room temperature by moving the web with keeping in contact with a can (a film-forming roll) cooled with water: a gas barrier layer comprising C in a thickness of 30 nm, an under layer comprising Ru in a thickness of 20 nm, and a magnetic layer comprising (CO₇₀—Pt₂₀—Cr₁₀)₈₈—(SiO₂)₁₂ in a thickness of 20 nm.

These gas barrier layer, under layer and magnetic layer were formed on both sides of the PEN film. Subsequently, the web was mounted. on a web type CVD apparatus, and a nitrogen-added DLC protective layer comprising C/H/N of 62/29/7 in molar ratio was formed in a thickness of 10 nm by an RF plasma CVD methodusing ethylene gas, nitrogen gas and argon gas as reaction gases. At this time, bias voltage of −500 V was applied to the magnetic layer. The protective layer was also provided on both sides of the PEN film. In the next place, a lubricating layer having a thickness of 1 nm was formed on the surface of the protective layer by coating a solution obtained by dissolving a perfluoro polyether lubricant having hydroxyl groups at the molecule terminals (FOMBLIN Z-DOL, manufactured by Montefluos Co.) in a fluorine lubricant (HFE-7200, manufactured by Sumitomo 3M Limited) by gravure coating. The lubricating layer was also formed on both sides of the film. A 3.5 inch size magnetic disc was punched out of the web, subjected to tape burnishing treatment, and built into a resin cartridge (for Zip 100, manufactured by Fuji Photo Film Co., Ltd.), thereby a flexible disc was obtained.

### Example 2

A disc-like sheet having a diameter of 130 mm was punched out of the web in Example 1 having formed thereon an under layer and fixed on a circular ring. The same gas barrier layer, under layer and magnetic layer as in Example 1 were coated on both sides of the sheet by a batch sputtering system, further a DLC protective layer was formed by a CVD system. The same lubricating layer as in Example 1 was formed on the sheet by dip coating. A 3.5 inch size disc was punched out of the sheet, subjected to tape burnishing treatment, and built into a resin cartridge (for Zip 100, manufactured by Fuji Photo Film Co., Ltd.), thereby a flexible disc was obtained.

### Example 3

A flexible disc was manufactured in the same manner as in Example 1 except for changing the thickness of the magnetic layer to 15 nm and the thickness of the under layer to 20 nm.

### Comparative Example 1

A flexible disc was manufactured in the same manner as in Example 1 except for changing the thickness of the magnetic layer to 30 nm and the thickness of the under layer to 40 nm.

### Comparative Example 2

A flexible disc was manufactured in the same manner as in Example 1 except for changing the thickness of the magnetic layer to 30 nm and the thickness of the under layer to 20 nm.

Evaluating Methods:

1. Magnetic Characteristics

Coercive force (Hc) was measured with a vibrating sample magnetometer (VSM). The results obtained are shown in Table 1 below.

2. C/N

Recording and reproduction of linear recording density of 400 kFCI were performed with a GMR head having a reproduction track breadth of 0.25 μm and a reproduction gap of 0.1 μm, and reproduction signal/integrated noise (C/N) ratio was measured. The engine speed was 4,200 rpm and the radial position was 35 mm. Taking the C/N value in Example 1 as a criterion, and each value was shown as the increase or decrease from the criterion. The results obtained are shown in Table 1 below.

3. Running Durability

The time required for each sample to generate shaving was measured in the measurement of C/N ratio. The longest time of measurement was 300 hours. The results obtained are shown in Table 1.

TABLE 1

| | | | |
|---|---|---|---|
| | | | Time Required |
| | | | to Generate |
| | Hc | C/N | Shaving |
| Example No. | (kA/m) | (dB) | (Hr) |

| | | | |
|---|---|---|---|
| Example 1 | 250 | 0 | >300 |
| Example 2 | 255 | +1.0 | >300 |
| Example 3 | 260 | +1.4 | >300 |
| Comparative | 240 | +0.6 | 94 |
| Example 1 | | | |
| Comparative | 250 | −0.2 | 252 |
| Example 2 | | | |

As can be understood from the results shown in Table 1, flexible discs in Examples that are magnetic recording media according to the invention are excellent both in recording characteristics and running durability. On the other hand, the disc in Comparative Example 1 having the total thickness of the under layer and the magnetic layer of 7.0 nm is sufficient both in coercive force and recording characteristics but very inferior and unsatisfactory in the point of running durability. This is probably due to the fact that the shaving of the disc occurs by the concentrated stress applied to the columnar structural part (the under layer and the magnetic layer) at the time of head-medium contact, which causes the reduction of running durability. In Comparative Example 2, where the total thickness of the under layer and the magnetic layer is 50 nm, coercive force and recording characteristics are sufficient, and running durability is ensured to a certain degree but not on a satisfactory level.

The magnetic recording medium according to the present invention is a magnetic recording medium capable of being preferably used in a high density magnetic recording apparatus, showing less interaction among ferromagnetic particles, generating low noise, having high running durability, and capable of being manufactured inexpensively by film-forming at room temperature.

This application is based on Japanese Patent application JP2003-165450, filed Jun. 10, 2003, the entire content of which is hereby incorporated by reference, the same as if set forth at length.

What is claimed is:

1. A magnetic recording medium comprising, in this order:
a flexible polymer support;
a gas barrier layer;
an under layer; and
a magnetic layer,
wherein the magnetic layer has a granular structure comprising a ferromagnetic metal alloy and a nonmagnetic oxide, and a total thickness of the under layer and the magnetic layer is from 10 to 45 nm.

2. The magnetic recording medium according to claim 1, wherein the total thickness of the under layer and the magnetic layer is from 10 to 30 nm.

3. The magnetic recording medium according to claim 1, wherein the magnetic layer has a part where a ratio of a content of a ferromagnetic metal alloy is predominant as compared with an entire composition of the magnetic layer and a part where a ratio of a content of a nonmagnetic oxide is predominant as compared with an entire composition of the magnetic layer.

4. The magnetic recording medium according to claim 1, wherein the ferromagnetic metal alloy is an alloy containing Co, Pt and Cr, an alloy containing Co, Pt, Cr and Ta, an alloy containing Co, Pt, Cr and B, or an alloy containing Co, Ru and Cr.

5. The magnetic recording medium according to claim 1, wherein the nonmagnetic oxide contains at least one of Si, Zr, Ta, B, Ti, Al, Cr, Ba, Zn, Na, La, In and Pb.

6. The magnetic recording medium according to claim 1, wherein the nonmagnetic oxide contains Si.

7. The magnetic recording medium according to claim 1, wherein the under layer contains an alloy containing Ru.

8. The magnetic recording medium according to claim 1, wherein the gas barrier layer contains a nonmetallic element, or a compound comprising Ti and nonmetallic element.

9. The magnetic recording medium according to claim 1, wherein the gas barrier layer has a thickness from 5 to 200 nm.

10. The magnetic recording medium according to claim 1, wherein the gas barrier layer has a thickness from 5 to 100 nm.

11. The magnetic recording medium according to claim 1, further comprising an undercoat layer so that the flexible polymer support, the undercoat layer and the gas barrier layer are in this order.

12. The magnetic recording medium according to claim 1, wherein the undercoat layer contains at least one of a polyimide resin, a polyamideimide resin, a silicone resin and a fluorine resin.

13. The magnetic recording medium according to claim 1, wherein the undercoat layer contains at least one of a thermosetting polyimide resin and a thermosetting silicone resin.

14. The magnetic recording medium according to claim 1, wherein the undercoat layer has a thickness of from 0.1 to 3.0 μm.
